(19) United States
(12) Patent Application Publication
(10) Pub. No.: US 2026/0030333 A1
(43) Pub. Date: Jan. 29, 2026

(54) CHALLENGE-BASED SYSTEM FOR HUMAN VERIFICATION THROUGH VOICE INTERACTIONS

(71) Applicant: AXD S.A.S., Bogotá (CO)

(72) Inventors: Juan David Sierra Murillo, Bogotá (CO); Jesús Antonio Londoño Muñoz, Bogotá (CO); Johan Sebastián Vargas Rodriguez, Bogotá (CO); José Daniel Sarmiento Blanco, Bogotá (CO); Carlos Alberto Sierra Murillo, Bogotá (CO)

(73) Assignee: AXD S.A.S., Bogotá (CO)

(21) Appl. No.: 19/283,390

(22) Filed: Jul. 29, 2025

Related U.S. Application Data
(60) Provisional application No. 63/676,516, filed on Jul. 29, 2024.

(51) Int. Cl. G06F 21/32; G10L 17/06; G10L 17/24

(52) U.S. Cl. CPC G06F 21/32; G10L 17/06; G10L 17/24

(57) ABSTRACT

A method for authenticating human voice using challenge-response techniques. The method begins with channel interaction, where the system establishes initial communication with the user through various channels, including mobile devices or online platforms. During this interaction, the user is requested to provide a voice sample, which is captured and processed to extract unique human features. Subsequently, the system presents the user with a challenge, including a random phrase or a sequence of words, requiring a verbal response. This response is captured and compared with the initial voice sample. Based on this comparison and the accuracy of the response to the challenge, the humanity of the user is determined.

### CROSS-REFERENCE TO RELATED APPLICATIONS

This application claims the benefit of priority to U.S. Provisional Application No. 63/676,516, filed Jul. 29, 2024, entitled, CHALLENGE-BASED SYSTEM FOR HUMAN VERIFICATION THROUGH VOICE INTERACTIONS, the contents of which are incorporated herein by reference.

### TECHNICAL FIELD

The present invention pertains to the field of computer science, particularly to the processing of digital data using computing systems based on specific computational models. More specifically, it relates to security measures designed to prevent unauthorized access and activities, and even more specifically, to establishing parameters for human voice validation, that is, setting conditions for authorization with a certain level of security.

### BACKGROUND

In today's digital environment, verifying user identity has become essential, particularly with the rapid expansion of computing solutions that require user identity confirmation. Increasingly, online transactions, access to sensitive information, and digital services depend on robust methods to ensure the user is who they claim to be. Voice biometrics has emerged as a popular method for this validation due to its convenience, simplicity, and ability to provide a smooth and intuitive user experience.

However, advancements in voice simulation technologies, driven by artificial intelligence, have led to the development of tools capable of mimicking human voices with remarkable accuracy. These technologies can replicate the nuances and patterns of the human voice so precisely that it becomes challenging, even for advanced systems, to distinguish between an authentic and a simulated voice. This situation poses a significant challenge to the security and integrity of voice authentication systems, as an impostor could use a synthetic voice to deceive these systems and gain unauthorized access.

Furthermore, as voice synthesis technologies continue to evolve, the threat becomes even more pronounced. Traditional voice authentication systems, which rely solely on analyzing vocal characteristics, become inadequate against these sophisticated imitations. This underscores the urgent need to develop more advanced and dynamic methods that can address this vulnerability and ensure that voice authentication remains a secure and viable option for identity verification in today's digital world.

It is well-known that a human voice authentication procedure is a set of techniques and processes designed to confirm the authenticity and origin of a set of sounds emitted by a source to determine whether the source is human or not. This determination is made based on auditory parameters or controlled validation environments that ensure the human origin of the sound, and in a more advanced aspect, the identity of a person based on their voice. Such procedures are used in security applications, access control, authentication, and origin verification. A typical procedure of these applications includes a voice capture stage, where a sample of the user's voice is recorded, potentially using a microphone on a device such as a phone, computer, or specialized system. This is followed by a voice preprocessing stage, where the recorded voice sample is processed to eliminate background noise and normalize or adjust the volume to an appropriate level, ensuring that the voice sample is clear and suitable for analysis.

The known technique involves additional stages of feature extraction, which include unique characteristics of the voice sample such as frequency, pitch, timbre, speech rate, and other biometric features that are difficult to imitate. This is followed by a comparison with a database, where these extracted features are compared to those in a database of previously recorded voices, typically using pattern recognition algorithms and machine learning.

Subsequent stages of the known technique involve validation and verification procedures. Generally, the system determines if the voice sample matches voices stored in the database, which may involve comparing the voice sample to a previously recorded voice model of the user. Following these validation and verification procedures, a conclusion phase is carried out, resulting in an authentication decision based on the comparison and analysis. The system decides if the voice is authentic; typically, if the voice matches the recorded voice, the user is authenticated and granted access, or the system permits the desired procedure. Conversely, if the voice does not match, access is denied, and in some cases, reattempt procedures may be performed, known as feedback and subsequent actions. Depending on the result, the system may provide feedback to the user or record the access attempt.

In some cases, additional security measures may be taken, such as requesting further or supplementary verification.

Authentication procedures, particularly those using biometric data, have a broad range of applications across various fields where secure yet convenient authentication is required. In the financial sector, these procedures are employed in online banking to access accounts, conduct transfers, and perform other transactions, as well as in ATMs in conjunction with additional recognition for cash withdrawals. They are also essential in mobile payments, enabling verification for payments via mobile devices, and in investment management, ensuring secure access to investment and brokerage platforms, and are also used in credit and loan applications to verify the applicant's identity.

In the corporate sector, such validations are crucial for access to corporate systems, allowing employees to securely enter networks and internal systems. They are applied in human resources management to control access to sensitive employee information and in electronic signatures, using data to advance electronic document signing. Additionally, they can be used in attendance control, recording staff entry and exit through biometrics, and in access control to high-security areas within the company.

In other application areas, such as education, validation is used to access e-learning platforms, verifying student identities before accessing online courses and during exams. It is also employed in libraries to access digital and physical resources and in grade management, ensuring secure access to academic records.

In the field of healthcare, voice validation facilitates secure access to electronic medical records and patient health records. It is used in medication dispensing to verify identity during medication administration and in controlling access to hospital facilities, ensuring that only authorized personnel can enter restricted areas. Furthermore, it is crucial in telemedicine, authenticating both patients and healthcare professionals in virtual consultations, and in medical research, enabling secure access to research data and clinical trials.

In the realm of security, biometric authentication is employed in border control to verify identity at points of entry and exit from countries. It is also used in surveillance and monitoring through facial recognition in security camera systems and in access control to government buildings, ensuring that only authorized individuals can enter. It is vital in police applications for identifying individuals in criminal investigations and in defense and military sectors, controlling access to defense installations and systems.

In the technology sector, biometric authentication is applied in smart devices for unlocking and accessing smartphones, tablets, and other devices. It is also used in virtual assistants, authenticating users in systems like Siri, Alexa, and Google Assistant, and in social media to verify identity and protect accounts. Additionally, it is employed in online gaming to authenticate players and protect their accounts and in streaming services to ensure access to accounts on platforms such as Netflix and Spotify.

In transportation, biometric authentication is utilized in airports for identity verification during boarding and access to restricted areas. It is also used in public transportation to authenticate passengers for service access and in smart vehicles, allowing start-up and use through biometric data. Furthermore, it is applied in fleet management, controlling access and use of vehicles in business fleets.

In everyday life, biometric authentication is used in smart homes to control access to home automation and security systems. It is also employed in gyms to manage access to sports facilities and services, and in events and entertainment to verify identity and allow entry to concerts, theaters, and other events. Additionally, it is essential in online shopping, ensuring authentication for secure purchases on e-commerce platforms, and in rental services, verifying identity for renting vehicles, properties, and more.

Finally, in research and development, biometric authentication is used in research laboratories for secure access to these facilities and in data centers, controlling access to servers and installations. It is also crucial in software development, authenticating developers and allowing access to code repositories. Biometric authentication is a continuously expanding field, with emerging new applications as technology advances and integrates into various aspects of daily and professional life.

While human voice validation procedures are advanced and effective, they may face several issues and challenges. Common problems include background noise or environmental noise, which can interfere with voice capture and processing, making it difficult to extract accurate features and perform effective comparisons. Additionally, changes in the user's voice due to factors such as illnesses, for example, a cold or temporary conditions like laryngitis, or chronic conditions such as asthma, can alter a person's voice, complicating validation. Emotional changes, aging, and vocal fatigue can also affect voice characteristics, leading to false rejections. Issues related to the emitter include variability in intonation and speech rate, as the way a person speaks can vary depending on context, emotional state, or simply their mood of the day, affecting validation consistency.

More complex problems arise with voice imitation, where individuals with voice imitation skills can deceive the system if it is not sophisticated enough to distinguish between genuine and imitated voices, leading to spoofing attacks where attackers use voice recordings or synthesizers to attempt to access protected systems. Security must be robust enough to detect and prevent such attempts.

Known issues also include failures in technological infrastructure, network problems, or software errors that can disrupt the voice validation process. The quality of recording equipment, where low-quality microphones or recording devices may fail to capture all necessary voice features, affecting system accuracy, is another concern. Additionally, the presence of different accents and dialects poses a challenge for proper information processing, as variations in accents and dialects can complicate voice comparison, especially in systems not trained with a diverse range of voice patterns.

Another significant consideration is the privacy and security of data during the collection and storage of voice samples. Systems must ensure that voice data is handled securely to protect user identity and privacy.

Addressing these issues involves continuous improvements in voice validation technology, the use of advanced machine learning techniques and neural networks and implementing robust security measures to protect against spoofing attempts and other types of attacks.

Synthetic voice imitations represent a significant threat to information systems that use voice interactions, as they can be employed to impersonate a person and access confidential information. This type of vocal fraud can deceive voice authentication systems, allowing attackers to gain unauthorized access to, for example, bank accounts, healthcare systems, or any other platform that relies on voice identity verification. The increasing accuracy and sophistication of advanced voice simulation systems, which leverage, for example artificial intelligence, heightens the risk of such attacks wherein these AI-driven systems can generate highly realistic voice clones, making it challenging for traditional signal processing-based identity verification systems to distinguish between genuine human and synthetic voices.

This vulnerability underscores the need to develop and implement more robust and secure multifactor authentication methods to protect sensitive data against these emerging threats; additionally, there is a growing necessity to create systems capable of more accurately determining whether the source of a voice is human or synthetic.

### SUMMARY OF THE INVENTION

This invention is designed to determine whether the origin of a voice is human, not by analyzing voice signals as existing solutions do, but by utilizing a system of challenges. The core of this invention is a multifaceted approach that leverages all the capabilities of the information system and the device used for validation to confirm the human nature of the interaction.

The challenges can take various forms beyond the mentioned types. For example, and not limited to:
image description wherein messages are sent to the user with images of different types, classes, colors, and sizes, and the user is asked to describe or name them.
pronunciation of misspelled words: deliberately misspelled words are sent to the user, and the user is asked to pronounce them correctly in sequence.
enhanced interaction: in devices such as smartphones, voice interaction can be enriched by sending text or images for the user to read or describe aloud.

These challenges fully utilize the capabilities of the system and the validation device, ensuring that verification is based not only on voice characteristics but also on the human ability to understand, interpret, and respond to complex stimuli wherein this approach not only confirms the human authenticity of the interaction but also enhances the security and accuracy of the verification process.

The primary object of protection is a voice validation process that includes an initial interaction stage between the user and the voice validation system. This interaction can be conducted through various channels such as telephone, mobile applications, or web systems. This initial stage determines how the voice sample will be captured, as the selected channel influences recording quality and the method of sample collection. During this stage, a challenge may also be presented to the user, integrated into the communication of the selected channel.

The process also includes a voice sample stage, where a recording of the user's voice is collected through the chosen interaction channel. This sample is crucial for subsequent analysis and comparison. The quality of the recording is fundamental to successful authentication, so preprocessing is performed to remove background noise and improve clarity. Additionally, unique humanity characteristics of the voice, such as tone, pitch, timbre, and formants, are extracted. These characteristics are necessary to distinguish between human voices and synthetic voices, as well as between different users.

Following this, the process presents a challenge to the user, which may consist of pronouncing a specific phrase, answering a question, or performing a verbal action. The challenge is presented through the same interaction channel, and the user's response is recorded and processed similarly to the initial voice sample. The design of the challenge is critical, as it must be difficult to predict or imitate to ensure the system can effectively distinguish between authentic human voices and synthetic ones. Additionally, the response to the challenge is checked for coherence and appropriateness within the context of the challenge, preventing the use of pre-recorded responses.

Finally, the process includes a result sample stage, where it is determined whether the user's voice is human based on the analysis of the voice sample and response to the challenge. The biometric characteristics of the response are compared with those of the initial sample and with voices stored in the database. Advanced machine learning algorithms and pattern recognition techniques are used to assess voice authenticity, looking for signs of spoofing such as inconsistencies in voice quality or significant differences in biometric characteristics. The result of this evaluation is communicated to the user through the interaction channel, indicating whether authentication was successful or if a new attempt or alternative verification method is required.

This flow ensures that each stage of the process builds on the information and actions of the previous stage, providing an integrated and effective voice validation system. Furthermore, security measures must be implemented to protect the privacy and integrity of data, ensuring a positive user experience adaptable to different usage contexts and connection conditions.

### BRIEF DESCRIPTION OF THE FIGURES

FIG. 1 illustrates a block diagram of the method for authenticating human voice using challenge-response techniques.

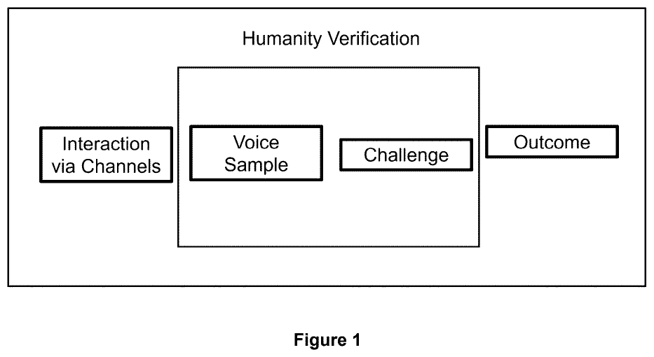

### DETAILED DESCRIPTION OF THE INVENTION

The present invention pertains to a computer-based method designed to enhance security in voice authentication by implementing a challenge-based verification system. This system is capable of differentiating between a genuine human voice and an artificially simulated voice based on responses to presented challenges, thus addressing the increasing need to protect users' digital operations. The significance of this invention lies in its ability to meet regulatory requirements for secure user authentication while providing a robust defense against identity fraud.

The system operates by presenting the user with a variety of challenges that require verbal responses. These challenges can include, but are not limited to, the following elements:

### Specific Word Pronunciation:

The user is required to pronounce randomly selected words. These words may include phonemes that are difficult for voice synthesis systems to replicate, and correct pronunciation is evaluated in real-time. This aspect ensures compliance with technical standards for voice biometric systems by incorporating real-time analysis.

### Image Descriptions:

The user is shown one or more images and asked to describe them. This task assesses not only the user's visual and verbal recognition skills but also the fluency and naturalness of the response, which simulated voices often struggle to accurately replicate. This method enhances the system's ability to meet legal standards for secure authentication by providing multi-modal verification.

### Simple Mathematical Operations:

The user is presented with mathematical operations to solve verbally. This type of challenge can include basic arithmetic operations or number sequences. The incorporation of cognitive tasks adds an additional layer of security, complying with regulatory requirements for multi-factor authentication.

### Induced Pronunciation Errors:

Words with deliberately induced pronunciation errors are presented, which the user must identify and correct. This task assesses the user's comprehension and correction abilities, which are challenging for AI systems to emulate. This component addresses the need for adaptive security measures that evolve with advancements in voice synthesis technologies.

### Evaluation Criteria:

The system evaluates responses based on various criteria, such as accuracy, response time, and the naturalness of pronunciation. Based on these data points, the system can accurately discern whether the response originates from a human or an AI-generated voice. This multi-criteria evaluation framework ensures the system's compliance with technical standards for voice biometrics and adaptive security measures.

### Legal Compliance and Security Enhancement:

By effectively distinguishing between human and simulated voices, this system provides an additional layer of security for user authentication, meeting legal requirements for safeguarding personal data. The structure and variety of challenges can adapt as voice simulation technologies evolve, ensuring the system remains effective and compliant with emerging legal standards.

This method not only enhances security but also dynamically adapts to improvements in voice synthesis technologies, ensuring continuous and effective protection against fraud. It aligns with legal mandates for secure user authentication and provides a robust mechanism to counteract identity theft and unauthorized access in digital environments.

The present invention relates to a method for authenticating human voice using challenge-response techniques and provides a secure and reliable way to verify a user's humanity through the analysis of their voice in response to specific challenges, thereby enhancing security in applications where human validation is crucial.

The method includes several key steps: firstly, a stage where the system establishes initial interaction with the user through various channels, such as mobile devices, telephone systems, or online platforms. During this interaction, the system requests the user to provide a voice sample, which is captured and processed to extract unique human characteristics, such as timbre, tone, rhythm, and other distinctive traits of the user's voice.

Once the voice sample is captured, the system presents a challenge to the user, which could be a random phrase, a sequence of words, security questions, or any other stimulus requiring a verbal response. The choice of challenges is crucial, as it must be sufficiently varied to prevent prediction or pre-recording of responses.

The user responds to the challenge by providing a new voice sample. This response is compared with the initial voice sample using advanced human recognition algorithms. These algorithms analyze whether the characteristics of the voice in the response match those of the initial sample and whether the response meets the expectations set by the challenge.

Finally, based on the comparison and analysis of the user's response, the system determines whether the user's identity is correctly verified. If authentication is successful, the user is granted access to the requested system or service.

If authentication fails, access is denied, and additional security measures may be taken, such as requesting further authentication or alerting the system administrator about the failed attempt.

This voice authentication method using challenge-response techniques has multiple practical applications. It is especially useful in environments requiring high security and convenience, such as banking systems, mobile devices, access control systems, and virtual assistants. Additionally, it can be applied in areas such as online banking, ATMs, mobile payments, investment management, attendance control in businesses, e-learning platforms, electronic health records, border control, surveillance and monitoring, smart devices, and many other fields.

In a preferred embodiment, interaction through channels refers to methods or means through which a user can interact with the system, including voice, text, gestures, or other communication channels.

In a preferred embodiment, the voice sample suggests that the system collects a voice sample from the user, with the voice sample being a human data used to verify the user's identity based on unique characteristics of their voice.

In a preferred embodiment, the challenge presents a challenge or series of challenges to the user to verify their humanity, which could involve answering questions, repeating phrases, or performing a specific action that a user can correctly respond to it and only if they are human.

In a preferred embodiment, the result or outcome is the final stage or section of the process and shows the outcome of the verification process, where, depending on the result, the system will determine if the person interacting with it is genuinely an authorized human.

The present invention refers to a method and system designed for voice authentication and verification, focusing on differentiating between human and synthetic voices using challenge-response techniques.

An object of protection refers to a specific method for authenticating human voice using challenge-response techniques, implying that specific challenges (such as phrases or questions) will be presented to users, and their responses (in voice form) will be analyzed to verify authenticity.

Another object of protection refers to a system and method designed to differentiate between human voices and voices generated by synthesis (such as those created by artificial intelligence software). It uses interactive challenges, likely involving active user participation, to make this differentiation.

Another object of protection refers to a voice verification process based on differentiating between human and synthetic speech, using challenges as the basis for this differentiation, with a focus on identifying unique characteristics of human speech that cannot be easily replicated by synthetic voices.

Another object of protection refers to a process and system focused on authenticating and verifying human voice by creating specific challenges that exploit the differences between natural and synthetic voices. These techniques are essential for enhancing security in voice recognition systems, particularly against threats like imitation and voice synthesis.

Another Object of Protection refers to a process and system focused on a particular interest in authentication and verification of humanity, comprising the following main stages:
Interaction by Channels
Voice Sample
Challenge
Outcome or result

Where the main stages of the voice validation process (Interaction by Channels, Voice Sample, Challenge, Outcome) interact as follows:

Interaction by Channels includes an initial communication phase between the user and the voice validation system, which can be through various channels such as telephone, mobile application, web system, etc. This stage involves establishing communication with other stages, as the selected channel determines how the voice sample (Voice Sample) will be captured, and the channel interaction may also include presenting the challenge to the user (Challenge).

Voice Sample involves capturing a sample of the user's voice through the interaction channel. This sample will be used for analysis and comparison, and its quality and clarity may depend on the interaction channel used. The voice sample will be compared with the responses to the challenge to verify authenticity (Challenge), and the collected data will be processed to determine the authentication result (Result).

Challenge presents a challenge or task to the user, such as pronouncing a specific phrase, answering a question, or performing a verbal action. The challenge is presented through the interaction channel, and the user's response to the challenge is the voice sample to be analyzed. The design and difficulty of the challenge influence the system's ability to differentiate between human and synthetic voices, and therefore, the final result (outcome).

Result is the determining stage for informing whether the user's voice is authentic or not, based on the analysis of the voice sample and the response to the challenge. The result depends on the quality of the collected voice sample, and the accuracy of the result is influenced by the effectiveness of the challenge in differentiating between human and synthetic voices. The result is then communicated to the user through the interaction channel, confirming or denying access.

The present invention refers to a method for authenticating human voice using challenge-response techniques, with the interaction flow comprising the following general stages:
Start: The user interacts with the system through a channel (Interaction by Channels).
Voice Capture: A voice sample of the user is collected (Voice Sample).
Challenge: The system presents a challenge to the user and collects their response (Challenge).
Analysis and Verification: The voice sample and response to the challenge are analyzed to determine authenticity and humanity (Result).
Outcome Communication: The result is communicated to the user through the interaction channel.

This flow ensures that each stage is based on the information and actions of the previous stage, creating a cohesive and effective voice validation system.

Additionally, the stages include these preferred embodiments and additional details to achieve validation:

### 1. Interaction by Channels

This stage involves the initial communication between the user and the voice validation system. It can be performed through various channels such as telephone, mobile application, web system, etc.

Channel Selection: Depending on the context, the interaction channel may be a phone call, mobile application, virtual assistant, or web interface.

User Instructions: Clear instructions are provided to the user on how to proceed with voice validation. This may include information on how to speak clearly, avoid background noise, and respond to the challenge.

Session Start: The system starts the authentication session and establishes a secure link for transmitting voice data.

### 2. Voice Sample

In this stage, a sample of the user's voice is collected through the interaction channel. This sample will be used for analysis and comparison.

Voice Recording: The system captures the user's voice. The quality of this recording is crucial for the success of the authentication.
1. Preprocessing: Background noise is removed, volume is normalized, and recording clarity is enhanced.
2. Feature Extraction: Unique human features of the user's voice are extracted, such as tone, rhythm, timbre, and formants. These data are necessary to differentiate between human and synthetic voices and other users.

### 3. Challenge

The system presents a challenge to the user, such as pronouncing a specific phrase, answering a question, or performing a verbal action.

Challenge Generation: The challenge can be a random phrase, a security question, or a series of words the user must repeat. The phrase or question is selected to be difficult to predict or imitate.

Challenge Presentation: The challenge is presented through the interaction channel. It can be displayed on screen, read by a virtual assistant, or sent as a text message.

Response Capture: The user responds to the challenge by speaking into the device. The response is recorded and processed in the same way as the initial voice sample.

Context Verification: Ensures the challenge response is coherent and appropriate to the challenge context, verifying it is not a pre-recorded message.

### 4. Outcome

In this stage, it is determined whether the user's voice is authentic or not, based on the analysis of the voice sample and the response to the challenge.

Response Analysis: The human features of the challenge response are compared with the features of the initial voice sample and with voices stored in the database.

Validation Algorithms: Machine learning algorithms and pattern recognition techniques are employed to evaluate voice authenticity and the accuracy of responses. This process involves comparing features such as intonation, rhythm, and phonetic structure, and determining whether the response to the challenge is correct.

Anomaly Detection: The system detects signs of impersonation by identifying inconsistencies in voice quality, evidence of audio editing, or significant discrepancies in human features or time delays in providing a response.

Result Determination: Based on the analysis and the response to the challenge, the system determines whether the voice is human or not. The result can be either a positive verification (successful verification) or a negative verification (verification rejection).

Result Communication: The result is communicated to the user through the interaction channel. If authentication is successful, access is granted, or the transaction is completed. If not, an additional attempt or an alternative verification method may be requested.

### Integration and Additional Considerations

Security and Privacy: Throughout the process, measures must be implemented to protect user privacy and the integrity of voice data. This includes data encryption, data retention policies, and compliance with privacy regulations.

User Experience: The process should be designed to be as smooth and convenient as possible for the user, minimizing friction and ensuring a positive experience.

Adaptability: The system should be adaptable to different use contexts, users with different accents and dialects, and unexpected situations such as variations in connection quality.

By detailing each stage of the process in this way, it is clear how they interact to form a cohesive, secure, effective, and user-friendly voice validation system.

The invention focuses on security provisions designed to protect computers, their components, programs, or data against unauthorized activities, with a particular emphasis on user authentication using human data. It encompasses the methodologies and technologies used to establish user identity or authorization, ensuring that only authorized individuals can access computer systems and sensitive information.

User authentication is based on the use of human features, such as fingerprints, iris scans, or voiceprints, to verify the user's identity. These data provide a more secure and reliable method of authentication compared to traditional passwords or two-factor authentication methods.

The objective of the invention is to develop and enhance human authentication technologies to ensure that computer systems are robust against potential attacks and unauthorized access, thereby protecting the integrity, confidentiality, and availability of data and computing resources.

In view of the foregoing, the present invention maintains the following advantages over the known techniques:

Enhanced Security: By effectively distinguishing between human and simulated voices, this system provides an additional layer of security for user authentication. The system's ability to accurately identify a genuine human voice versus an AI-generated voice significantly reduces the risk of fraud and unauthorized access. This is crucial in sectors where information security is a priority, such as online banking, personal data management, and secure communication platforms.

Adaptability: The structure and variety of challenges can adapt as voice simulation technologies evolve, ensuring the system remains effective. This flexibility allows the system to stay at the forefront of emerging threats and voice simulation techniques. Additionally, the ability to update and modify challenges ensures that the system can quickly respond to changes in the technological environment and tactics used by malicious actors.

Personalized User Experience: By offering a range of challenges, the system not only ensures secure authentication but also provides a richer and more interactive user experience. Users encounter diverse tasks that can be more engaging and less monotonous compared to traditional authentication methods. This advantage can enhance user satisfaction and increase the adoption and usage of the system in everyday applications.

Reduction of False Positives and Negatives: By employing multiple evaluation criteria, such as pronunciation accuracy, response time, and voice naturalness, the system can reduce the incidence of false positives and negatives. This means that it is less likely for a legitimate human user to be erroneously rejected or for a synthetic voice to go unnoticed, thereby increasing the reliability of the verification process.

Regulatory Compliance: This system can assist organizations in meeting security and data privacy regulations by providing a robust method for verifying user humanity. Companies can demonstrate that they are taking proactive measures to protect user data and prevent unauthorized access, thus aiding in compliance with relevant regulations.

Multi-Platform Integration: The solution can be integrated across a variety of platforms and devices, from mobile applications to interactive voice response (IVR) systems and virtual assistants. This versatility allows for implementation in different contexts and use cases, providing an additional layer of security at various access points.

Reduction of Fraud and Identity Theft: By focusing on verifying the humanity of the user rather than just the authenticity of the voice, the system offers more comprehensive protection against fraud and identity theft. This is particularly useful in scenarios where attackers might attempt to use recordings or synthesized voices to impersonate legitimate users.

Resource Optimization: By incorporating this verification system, organizations can optimize their security resources by reducing the need for additional authentication methods that may be more costly and less convenient for users. This also contributes to a reduction in operational costs associated with managing and resolving fraud incidents.

In summary, the invention not only improves security by distinguishing between human and simulated voices but also offers adaptability to new threats, an enhanced user experience, and several additional advantages such as reducing false positives and negatives, regulatory compliance, multi-platform integration, fraud reduction, and resource optimization. This ensures that the system remains relevant and effective in an ever-evolving technological landscape.

The algorithms and visualizations described in this document are not intrinsically tied to any specific computing device, virtualized system, or particular apparatus. Instead, they can be applied to various general-purpose systems with programs in accordance with the teachings provided here, or it may be beneficial to design more specialized equipment to carry out the required method steps. The necessary structure to implement these systems will vary, and this structure will be clear from the description provided in the document. Additionally, the system and method described are not associated with any specific programming language. It is understood that multiple programming languages can be used to implement the described teachings, and any previous mention of specific languages is made solely to facilitate disclosure and the best mode of implementation.

Consequently, the various embodiments of this invention include software, hardware, and/or other components for managing a computing system, electronic device, or other devices, whether individually or in combination. Such an electronic device may include, among other things, a processor, input devices (such as keyboard, mouse, touchpad, joystick, trackball, microphone, etc.), output devices (such as display, speaker, etc.), memory, long-term storage (such as magnetic storage, optical storage, etc.), and/or network connectivity, using well-known techniques in the industry. This device can be portable or non-portable. Examples of electronic devices that can implement the described system and method include desktop computers, laptops, televisions, smartphones, tablets, music players, audio devices, kiosks, set-top boxes, gaming systems, wearable devices, consumer electronics, servers, among others. These devices can operate with any operating system, such as Linux; Microsoft Windows from Microsoft Corporation; Mac OS X from Apple Inc.; iOS from Apple Inc.; Android from Google Inc.; or any other compatible operating system.

Although the document details a limited number of embodiments, those skilled in the art may devise other variations based on the provided description. Additionally, the language used in the specification has been chosen primarily to facilitate readability and instruction, and not necessarily to define or limit the scope of the invention. Consequently, the disclosure should be considered illustrative and not limiting of the patent's scope.

In conclusion, this patent provides an innovative approach to human voice validation, ensuring that voice interactions are genuine and not generated by automatic synthesis. The described methods and algorithms are not tied to any specific device or particular system, allowing for implementation across a wide range of hardware and software. This flexibility includes a variety of electronic devices and operating systems, from computers and smartphones to embedded systems and portable devices. The technology can be integrated into various contexts and applications, providing robustness and adaptability in detecting authentic human voices. The detailed description in the document should be interpreted as an illustrative guide, intended to cover the broad spectrum of possible implementations and not to limit the scope of the invention.

1. A method for authenticating a human voice using challenge-response techniques, the method comprising the steps of:
interacting with a user through one or more communication channels;
requesting and capturing a first voice sample from the user during the initial interaction;
presenting the user with a specific challenge that requires a verbal response;
capturing a second voice sample from the user in response to the presented challenge;
comparing the first voice sample with the second voice sample using human recognition algorithms to determine if the first voice sample and the second voice sample match;
determining the authenticity of the user's identity and if the voice samples are human based on the comparison step and the verbal response.

2. The method according to claim 1, wherein the interaction step is carried out through mobile devices, telephone systems, or online platforms.

3. The method according to claim 1, wherein the first and the second voice samples includes human characteristics including at least one of a voice timbre, a voice pitch, or a voice rhythm.

4. The method according to claim 1, wherein the challenge presented to the user is a random phrase, a sequence of words, a security question, a specific word pronunciation, image descriptions, mathematical operations, or induced pronunciation errors.

5. The method according to claim 1, wherein the human recognition algorithms used for comparing voice samples are advanced algorithms that analyze specific characteristics of the voice to verify the user's identity.

6. The method according to claim 1, wherein the determining step includes granting access to a requested system or a service if authentication is successful, and denying access if authentication fails.

7. The method according to claim 6, wherein in the case of authentication failure, additional security measures are taken, such as requesting additional authentication or alerting the system administrator about the failed attempt.

8. The method according to claim 1, wherein the method is use in banking systems, mobile devices, access control systems, virtual assistants, online banking, ATMs, mobile payments, investment management, business attendance control, e-learning platforms, electronic health records, border control, surveillance and monitoring, or smart devices.

9. A human voice authentication system that implements the method of claim 1, which includes components for interacting with the user, capturing voice samples, presenting challenges, comparing voice samples, and determining the authenticity of user's humanity.
